(19) United States
(12) Patent Application Publication
(10) Pub. No.: US 2008/0089366 A1
(43) Pub. Date: Apr. 17, 2008

(54) High energy short pulse fiber laser achieved by combining pulse shaping, polarization shaping and spectral shaping

(75) Inventor: Jian Liu, Sunnyvale, CA (US)

Correspondence Address: Bo-In Lin, 13445 Mandoli Drive, Los Altos Hills, CA, 94022, US

(73) Assignee: PolarOnyx, Inc.

(21) Appl. No.: 11/803,978

(22) Filed: May 15, 2007

Related U.S. Application Data
(60) Provisional application No. 60/800,327, filed on May 15, 2006.

(51) Int. Cl. H01S 3/30

(52) U.S. Cl. 372/6

(57) ABSTRACT

A fiber laser system includes a fiber mode-locking oscillator, a fiber stretcher, a multistage amplifier chain, a pulse picker, and a compressor wherein at least a device for performing a pulse shaping, a spectral shaping and a polarization shaping and a combination thereof is implemented in the fiber mode-locking oscillator, the fiber stretcher, the multistage amplifier chain, the pulse picker, and the compressor for managing and reducing nonlinear effects in the fiber laser system. The combinations of pulse shaping, spectral shaping and polarization shaping in different stages of the fiber laser system enables the fiber laser system to generate a short pulse of <200 fs and a high energy laser in a range between 1 uJ to over mJ and an average power from 1 W to 100 W.

This Formal Application claims a Priority Date of May 15, 2006 benefit from a Provisional Patent Applications 60/800,327 filed by the same Applicant of this Application. The disclosures made in 60/800,327 are hereby incorporated by reference in this patent application.

### FIELD OF THE INVENTION

The present invention relates generally to apparatuses and methods for providing high-energy short pulse fiber laser. More particularly, this invention relates to new configurations and methods for providing a high-energy short pulse fiber laser by combining pulse shaping, polarization shaping and spectral shaping.

### BACKGROUND OF THE INVENTION

Short pulse high-energy fiber layer, for example a laser with a pulse of less than 200 fs and an energy level substantially between 100 uJ to over mJ, is still a challenge to all the researchers and engineers. FIG. 1 illustrates the comparison of energy extraction from fiber amplifier/laser for two extreme pulse widths; i.e., 150 fs and 1 ns. The comparison demonstrates the challenges faced by all those of ordinary skill in the art due to the large nonlinear effects, such as the SRS and SPM effects in the fiber laser systems. Conventional approaches to achieve micro-Joul pulse, such as chirped pulse generation and amplification are still limited by the third order dispersion (TOD), SPM that causes the frequency chirping, and also the gain narrowing effects.

Therefore, a need still exists in the art of fiber laser design and manufacture to provide a new and improved configuration and method to provide fiber laser to enable the management of the significant nonlinear effects, the TOD difficulties, and the gain narrowing effects by a combination of techniques of spectral shaping, pulse shaping and polarization shaping such that the above-discussed difficulties may be resolved.

### SUMMARY OF THE PRESENT INVENTION

It is therefore an object of the present invention to provide system configurations and methods for applying the combinations of pulse shaping, spectral shaping and polarization shaping in different stages of a high-energy ultra-short pulse fiber laser system to manage and reduce the nonlinear effects. By combining the pulse shaping, spectral shaping and polarization shaping, a short pulse of <200 fs) and high energy, e.g., 100 uJ to over mJ, fiber laser with average power from 1 W to 100 W is achievable and the above discussed difficulties and limitations can be resolved.

Briefly, in a preferred embodiment, the present invention discloses a fiber laser system that includes a fiber mode-locking oscillator, a fiber stretcher, a multistage amplifier chain, a pulse picker, and a compressor wherein at least a device for performing a pulse shaping, a spectral shaping and/or a polarization shaping and/or a combination thereof is implemented in said fiber mode-locking oscillator, said fiber stretcher, said multistage amplifier chain, said pulse picker, and said compressor.

In a preferred embodiment, this invention further discloses a method for overcoming multiple nonlinear effects in a fiber laser system. The method includes a process of performing at least a process of a pulse shaping, a spectral shaping and a polarization shaping and a combination thereof in at least a stage of a laser system comprising a fiber mode-locking oscillator, a fiber stretcher, a multistage amplifier chain, a pulse picker, and a compressor.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A and 1B are diagrams for shown the comparison of energy extraction from fiber amplifier/laser for two extreme pulse widths: 150 fs and 1 ns conditions respectively.

FIG. 2 is schematic diagram for showing a high power/energy fs fiber laser system.

FIG. 3 illustrates the effects of Pulse shaping of this invention.

FIG. 4 illustrates the effects of Spectral shaping of this invention.

FIG. 5 illustrates the effects of Polarization shaping of this invention.

FIGS. 6A to 6C are functional block diagrams for two alternate fiber-based one-micron mode-locked fiber lasers as seed oscillators implemented in the high power/energy fs fiber laser system of FIG. 2.

FIG. 7 shows the dispersion and index profile of the fiber in reduction of TOD of this invention.

FIG. 8 shows the desired fiber stretchers with dispersion control for pulse shaping at 1 um band of this invention.

FIGS. 9A and 9B show the polarization shaping and spectral shaping respectively for getting an improved spectral shape in a first amplifier stage of this invention.

FIG. 10 shows the pulse shape of the filtered laser for carrying out a spectral shaping of the signal pulse of this invention.

FIG. 11 is a schematic diagram of a high power amplifier for femtosecond pulses of this invention.

FIG. 12 is a cross sectional view of double cladding LMA Yb doped photonics crystal fiber

FIG. 13 is a cross sectional view of an air core photonics band gap fiber.

FIGS. 14A and 14B are diagrams for showing comparisons of the input and output spectral shapes respectively with and without spectral shaping.

FIG. 15 is diagram for showing the damage threshold versus mode field diameter.

### DETAILED DESCRIPTION OF THE INVENTION

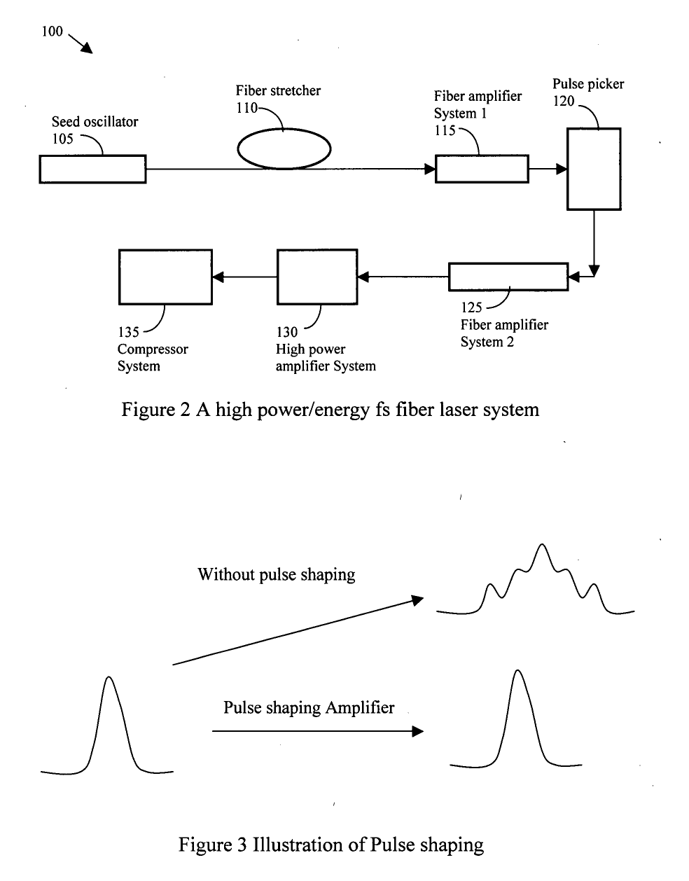

Referring to FIG. 2 for a schematic diagram of a fiber laser system 100 of this invention to implement a method of combining polarization shaping, spectral shaping and/or pulse shaping in a high energy short pulse laser system to eliminate the nonlinear effects and the third order dispersions (TOD), the frequency chirping caused by SPM and the gain narrowing effects. The high-energy short pulse laser system includes a seed oscillator 105 for generating a seed laser with a 20-100 MHz repetition rate femtosecond pulses. The seed laser is projected to a fiber stretcher 110 for stretching the pulse width in a range from one hundred ps to 10 ns. The stretched laser pulse is then transmitted to a fiber amplifier system 1, amplifier system 115 to amplify the stretched pulse to a high power of a few hundreds of mW. The amplified laser is then processed through a pulse picker 120 in down selection of repetition rate from tens of kHs (10 kHz) to several MHz and then projected to a fiber amplifier system 2, i.e., amplifier 125 to amplify the signal that is then projected to a high power amplifier system 130. The high power amplifier system 130 amplifies the laser to a level of energy/power from uJ to mJ with average power from 1 W to 100 W. The amplified high power laser is then projected into a compressor 135 for compressing the pulse back to femtosecond level (for example, <200 fs). The technologies of pulse shaping, spectral shaping and polarization shaping as will be further described below may be implemented in any stages of optical processes in anyone of these components.

In order to better understand the inventions disclosed in this Application, the key technologies of pulse shaping, spectral shaping and polarization shaping are first described below.

Pulse shaping: FIG. 3 illustrates the effects of carrying out a pulse shaping process by manipulating the nonlinear effects and dispersion of the whole fiber laser system in time domain. As shown in FIG. 3, due to the serious nonlinear effects such as SPM and SRS effects, the laser pulse has an irregular distorted pulse shape when the pulse shaping techniques implemented with a total system nonlinear effect management of this invention as discussed below are applied. The irregular distorted pulse shapes are generated due to the uncompressed nonlinear chirp of frequency. In order to overcome such problems, amplifier with proper SPM, dispersion and TOD are implemented as further discussed below to perform a pulse shaping such that the irregular and uncontrollable pulse shape distortions can be mitigated

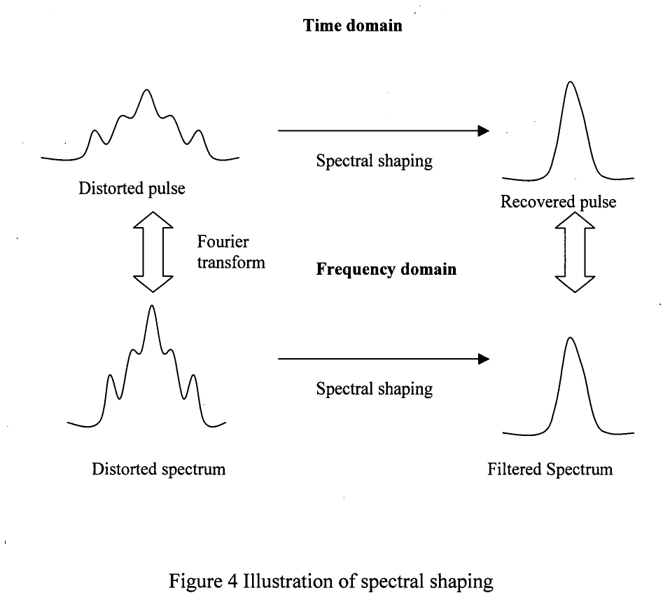

Spectral shaping: As illustrated in FIG. 4, by controlling the spectrum in the fiber laser system (in frequency domain), the pulse can be amplified and the pulse shape can be maintained as well because of a tight correlation (Fourier transform relation) between time domain and frequency (spectrum) domain. By adding spectral filter in filtering the spectrum of the pulse, the time domain can have a good pulse shape. This adds another freedom for pulse shaping in addition to handling with SPM & dispersion.

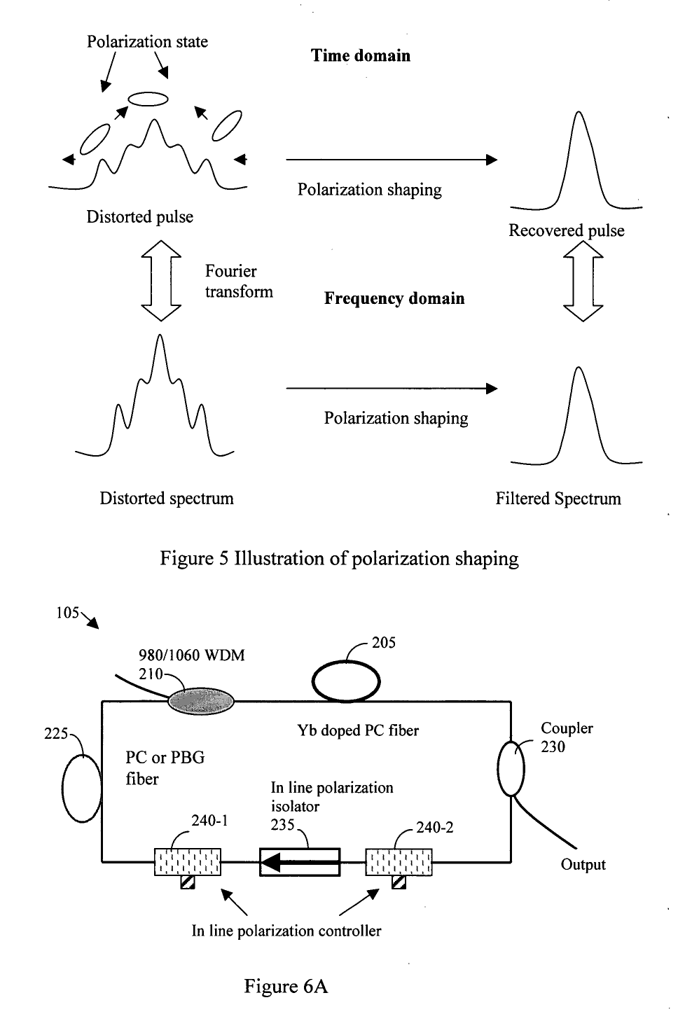

Polarization shaping: As illustrated in FIG. 5, Due to a high peak power in the amplifier, the polarization of the pulse changes as a function of the power distribution level in the pulse envelop in the time domain and accordingly as a function of wavelength of the pulse spectrum. This may cause a polarization dependent nonlinear chirp on the pulse, which will distort the pulse and make the pulse uncompressible. By controlling the polarization, e.g., controlling the polarization by using the polarizer and wave retarder, to select a proper shape of the polarization related pulse, i.e., spectrum, the shape of the pulse can be manipulated to maintain a compressible pulse shape after amplification and ready for pulse width compression.

As discussed below, the system as disclosed in this invention involves innovation that applies the polarization shaping, the pulse shaping, and/or the spectral shaping at all stages of the fiber laser system shown in FIG. 2

1. Seed Oscillator

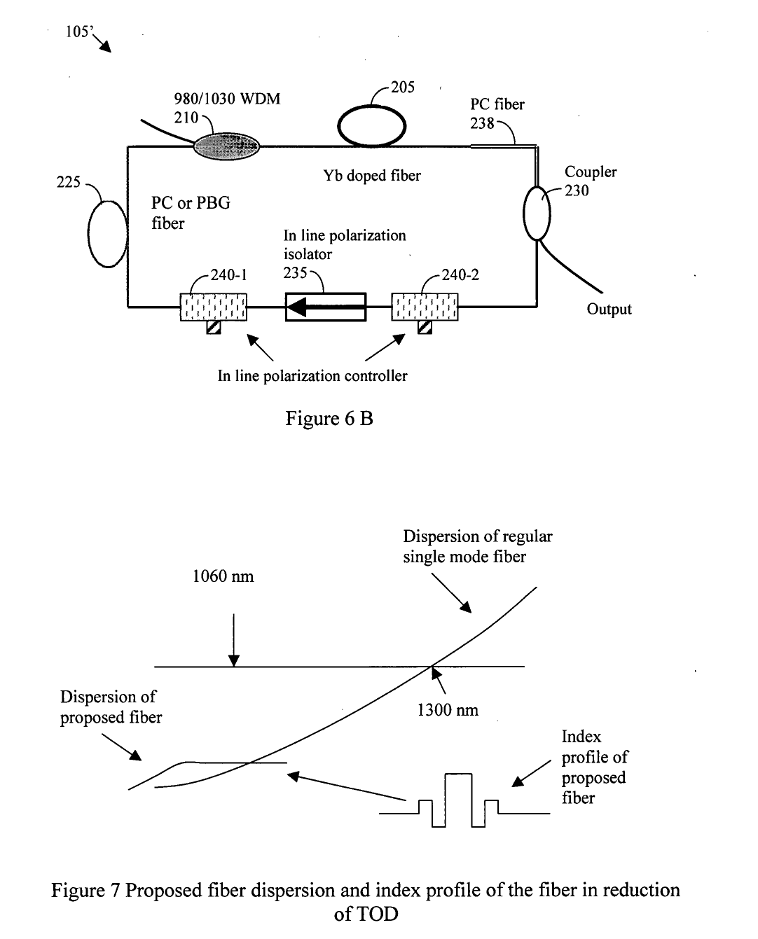

FIG. 6A is a functional block diagram of an exemplary embodiment of a seed oscillator implemented with nonlinear pulse shaping to output highly chirped pulse directly from a seed laser oscillator. This is a seed laser oscillator 105 formed with all fiber-based components. The fiber laser has a ring configuration receiving a laser input through wavelength de-multiplexing (WDM) device 210 of a source laser that may have ranges of wavelengths, e.g., 980 or 1550 nm. The all fiber-based seed oscillator 105 is implemented with a Yb doped fiber 205 as a gain medium to amplify and compress/stretch the pulse. The Yb gain fiber can be either PC fiber or regular single mode Yb doped fiber. A telecom grade 980 nm pump laser is used to pump Yb ions for amplification of the intra cavity pulses. To compensate the dispersion and dispersion slope in the fiber laser cavity, instead of using grating pairs or prisms, another photonic crystal fiber or PBG fiber 225 is employed. Because PC or PBG fibers 225 can provide both normal and anomalous dispersion at 1060 nm range with its uniquely structured properties and can also manipulate their dispersion slope, a fiber laser cavity can be designed with both dispersion and dispersion slope matched so the pulse can be narrowed to the maximum. The polarization filtering is achieved by managing both dispersion and dispersion slope and further by using fiber-based inline polarizing isolator and polarization controllers. The all fiber-based laser 105 employs an in-line polarization controller 240-1 and 240-2 before and after an in-line polarization sensitive isolator 235 that is implemented with single mode (SM) fiber pigtails. The in-line polarization sensitive control may be a product commercially provided by General Photonics, e.g., one of PolaRite family products. The polarizing isolator 235 has a high extinction ratio and only allows one linear polarization pass through over a wide spectrum. FIG. 6B shows an alternate all-fiber based high power seed oscillator 105′ similar the all-fiber laser seed oscillator 105 shown in FIG. 6A with the exception of implementation of a Photonic crystal (PC) fiber 238 that is connected to the optical coupler 230. By using either a Photonic crystal (PC) or a Photonic band gap (PGB) fiber.

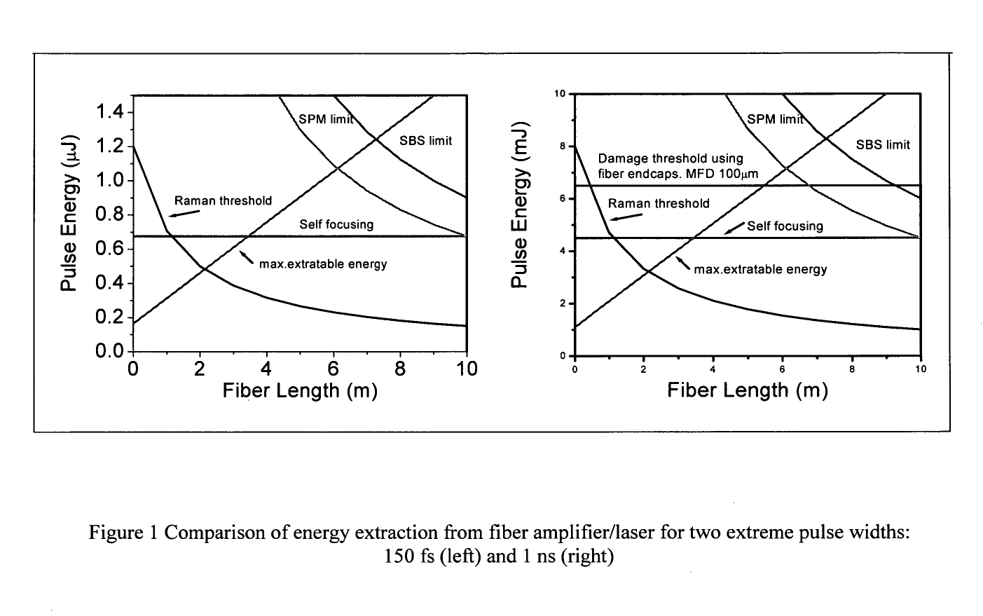

Generally the seed laser can output laser pulse with pulse width of several ps. However, by placing the output fiber at the right location or using Photonic crystal fiber with high dispersion, it is possible to extract highly chirped pulse of 100 s of ps directly out of the cavity. FIGS. 6A and 6B are block diagrams of two exemplary embodiments. The feature of the seed laser for chirping the pulse to over hundreds of ps is important for further extraction of the energy in amplification stage. By using Photonic crystal (PC) or photonic band gap (PBG) fiber for chirping the pulse can achieve highly chirped pulse with short length, because PC and PBG fibers shows large dispersions, e.g., over 100 ps/nm/km, absolute value, in normal and anomalous dispersions. Referring to FIG. 1 again for an example of a comparison of the pulse energy extractions for the laser of 150 fs pulse and 1 ns pulse. The comparison clearly shows that in order to achieve amplification to the mJ level, seed lasers of hundreds of ps pulse are required. The seed oscillators as shown in FIGS. 6A and 6B are also disclosed in prior Patent Applications 60/560,984 filed on Apr. 12, 2004, 60/634,116 filed on Dec. 8, 2004, Ser. No. 11/093,519 filed on Mar. 29, 2005, and Ser. No. 11/136,040 filed on May 23, 2005. The disclosures made in these Applications are hereby incorporated by reference.

By applying the techniques of polarization shaping with the employment of inline polarization dependent isolator 235 and polarization controllers 240-1 and 240-2 to act as a fast saturation absorber to select right polarization of the lasing pulse, and to further perform the pulse shaping with a cavity dispersion control, the mode-locking mechanism can be realized and very short transform limited pulse (<100 fs) can be achieved from the seed oscillator. Please refer to the Patent Applications 60/560,984 filed on Apr. 12, 2004, 60/634,116 filed on Dec. 8, 2004, Ser. No. 11/093,519 filed on Mar. 29, 2005, Ser. No. 11/136,040 filed on May 23, 2005, and Patent Applications 60/669,331, and 60/653,102 for further reference to the disclosures of the nonlinear polarization pulse shaping of the mode locked fiber laser at one-micron fiber lasers.

2. Fiber Stretcher

Referring to FIG. 1 again, between the seed oscillator 105 and the amplifier 115, a short piece of PC fiber, usually with large normal dispersion, or a SM 28 fiber is added to function as a stretcher 110 to dispersively stretch the pulse to over 100 ps. For the stretcher 110, it is highly desirable to design a fiber that has a flat dispersion over the range of 1020-1090 nm, similar to that dispersion flattened fiber used in 1550 nm spectral band by using a depressed cladding structure. FIG. 7 shows an example of the index profile for this type of fiber and possible flattened dispersion at 1 μm spectral band. This type of pulse shaping method helps maintain the pulse shape and reduce distortion in the whole fiber laser system.

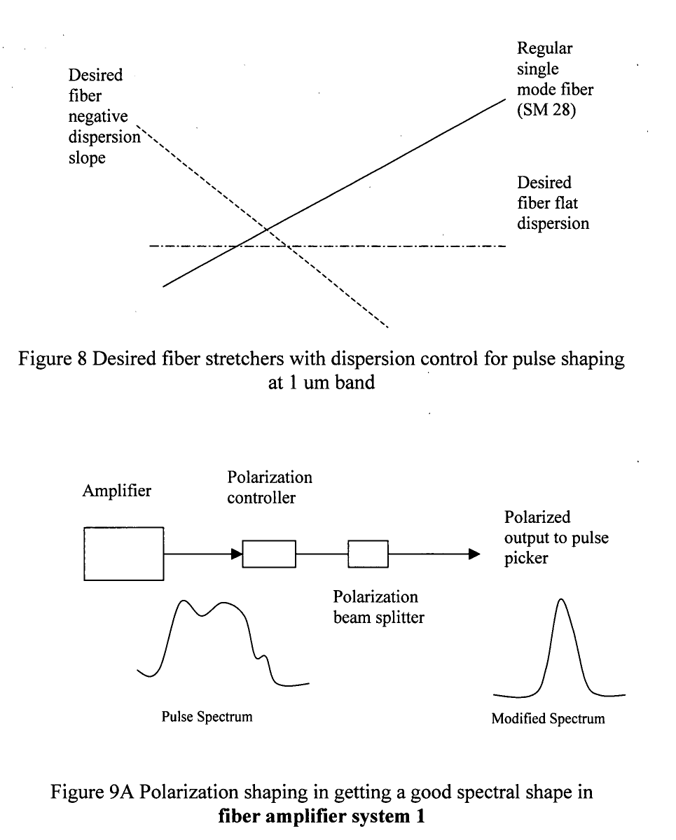

Moreover, since the sign of the third order dispersion (TOD) in both the regular fiber and the grating fiber are same, it is desired to design a fiber with negative dispersion slope to further reduce the TOD effects from the gratings if nonlinear SPM cannot completely compensate the TOD of the gratings. FIG. 8 shows a stretcher with a negative dispersion slope to provide the dispersion control to carry out a function of pulse shaping with two dispersions of a positive and a negative dispersion slopes for providing a stretcher with flat dispersion at 1 μm band as shown in FIG. 8. The same Inventor of this Application disclosed a dispersion management stretcher in another Provisional Patent Applications 60/781,434 filed on Mar. 6, 2006 and a Formal application Ser. No. 11/715,420 filed on Mar. 6, 2007. The disclosures made in 60/781,434 and Ser. No. 11/715,420 are hereby incorporated by reference in this patent application.

3. Fiber Amplifier System 1

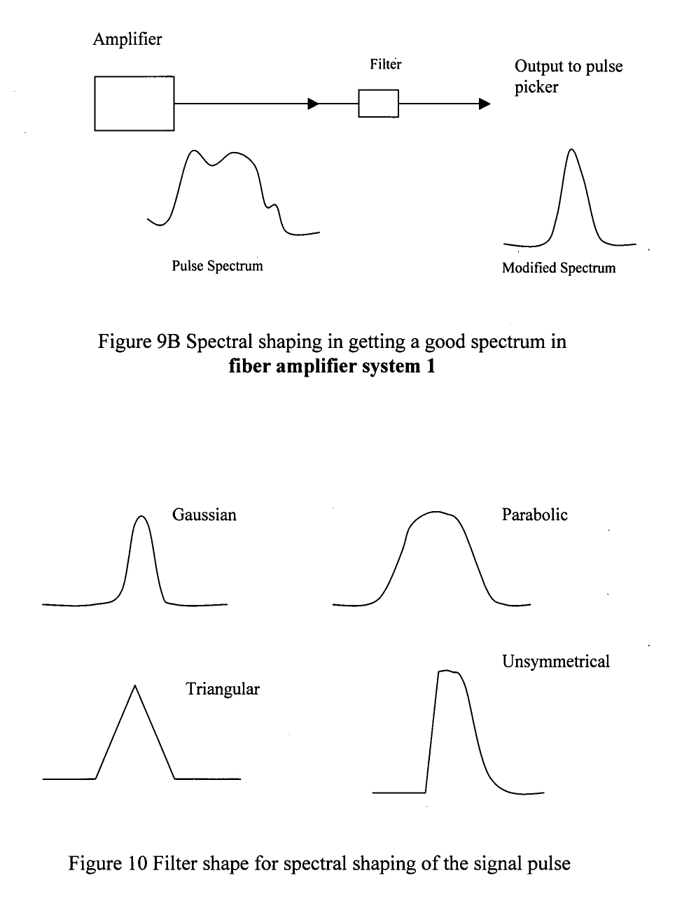

In the first fiber amplifier stage 115, the signal will be amplified to a few hundreds mW by either single stage amplifier or double stage amplifiers. FIG. 9 shows a functional block diagram of the first amplifier state 115 implemented with a polarization controller 116 and a polarization beam splitter (PBS) 118 for carrying out the functions of spectral shaping and polarization shaping. With spectral shaping and polarization shaping in this stage filter/modify the pulse/spectrum, the pulse or spectrum that has some imperfect and distorted shapes can be modified and shaped as shown in FIGS. 9A and 9B. One or both of the functions of spectral shaping and polarization shaping may be performed alone or combined in the first amplifier stage 115. The locations of the polarization controller 116 and the beam splitter 118 and/or filters can be flexibly arranged depending on the designs of the amplifiers. These optical devices can be used between the amplifiers to assure high output power of laser for transmitting to the pulse picker 120. In addition to the polarization controller and PBS, a spectral filter can be inserted to shape the pulse. The amplifiers used in this stage 115 can be either polarization maintenance (PM) or non-PM amplifiers.

4. Pulse Picker

For the purpose of achieving high-power short pulse laser output with combined and controllable pulse shaping, spectral shaping and polarization shaping, the pulse picker 120 can be also designed to have certain spectral bandwidth and shape to further enhance the operations of the spectral shaping. The pulse picker used here can be acoustic optical modulator in down-selecting the pulses. Since the pulse picker is driven by RF signal in generating a transmission type dynamic grating (ON/OFF). There are flexibilities to modify the RF signal waveforms and the RF frequencies to obtain the required shape of the spectrum, as those described in FIG. 4. By properly adjusting the shape and spectrum as that shown in FIG. 4, a more compact system configuration may be achieved by eliminating the filter or polarization controller as implemented in the fiber amplifier system 1 as described in section 3 above.

5. Fiber Amplifier System 2

Depending on pulse repetition rate, when the pulse rate is higher than 100 kHz, one pulse picker is sufficient to generate an output with a high enough average power for next stage amplification. However, if pulse rate is less than 100 kHz, another stage amplifier and one more pulse picker has to be used in the second fiber amplifier 125 to prevent performance degradation due to noise for the lower sampling rate, e.g., when the sampling rate is less than 100 kHz.

This second amplification stage 125 may be implemented with a PM version of amplifier to maintain the spectral shape and keep the polarization unchanged from the pulse picker that has a PM output signal. The second amplification stage 125 may also include a filter to further clean up the noise band outside the signal band and modify the spectrum to compensate the nonlinear effects in high power amplifier stage. This amplification stage 125 can have either one or two amplifiers. With the use of a second pulse picker, a second amplifier should be used in this second amplification stage 125.

The filters used for Spectral shaping in this amplification stage 125 can have various shapes in addition to the transform limited shapes, i.e., the Gaussian or parabolic shapes. Triangular and unsymmetrical shapes may be the choices. FIG. 10 shows some examples. The shape of the filtered pulses, shown as Gussian, parabolic, triangular or unsymmetrical pulses, is selected to achieve better pulse shaping performance in the next high power amplifier stage.

6. High Power Amplifier

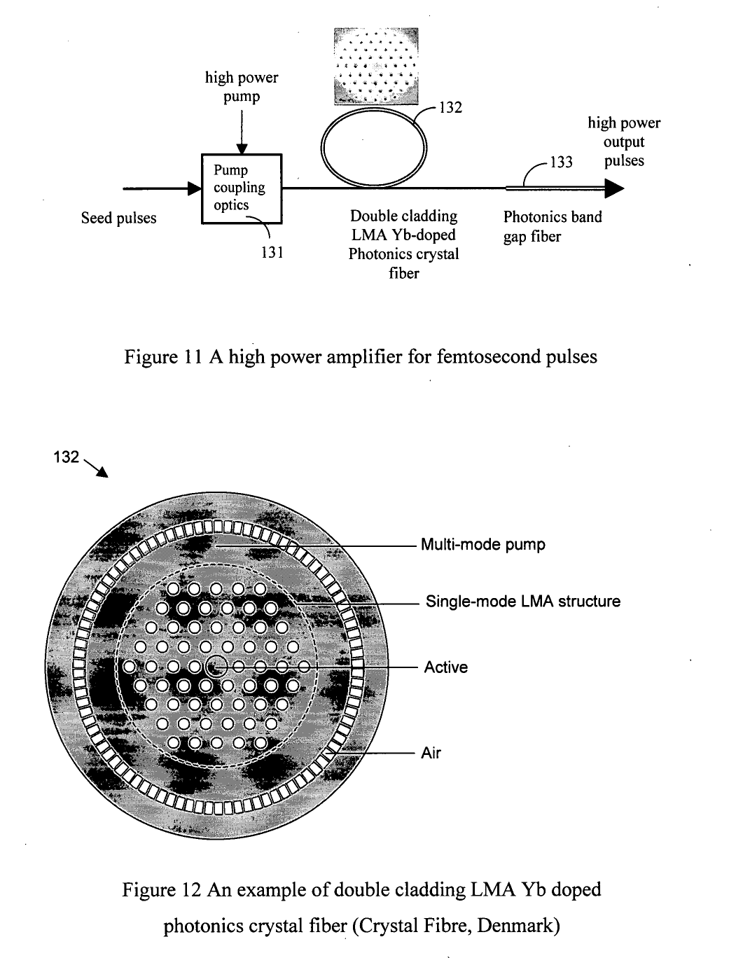

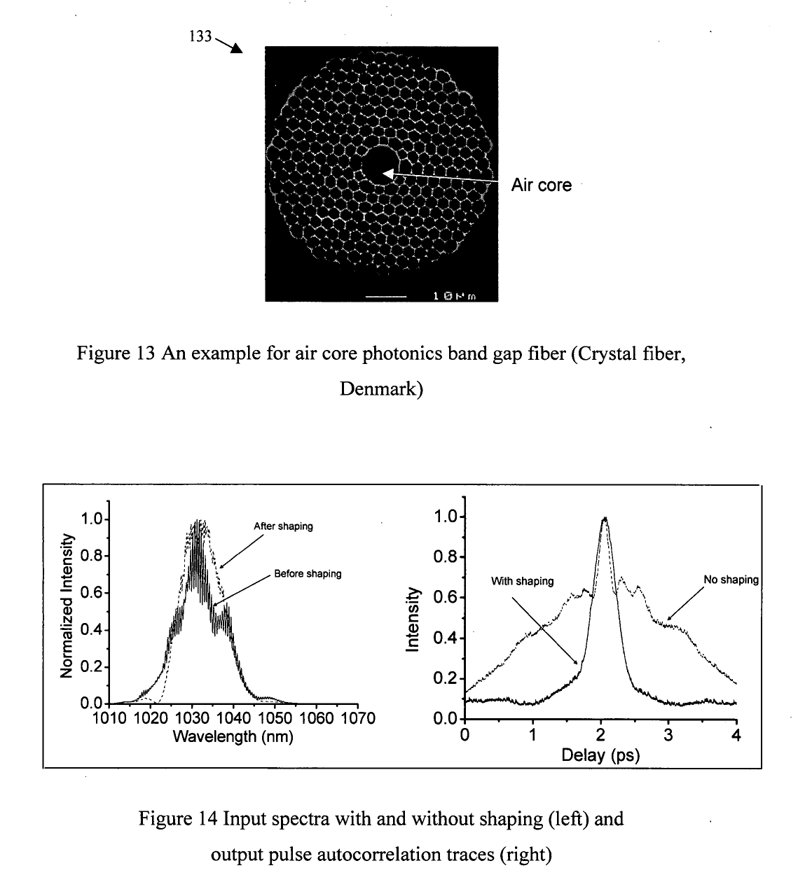

FIG. 11 is a schematic diagram for showing an exemplary ultra-short femtosecond fiber implemented in the high amplifier stage 130. The high power amplifier stage 130 includes pump coupling optics 131 coupled to a high concentration double cladding (DC) Yb-doped photonics crystal (PC) fiber 132 as a gain medium. High power pump that pumps lasers of 915 nm, 965 nm, or 976 nm are used to pump Yb ions for amplification of the chirped pulses (100's ps) through the coupling optics 131 or fiber pump combiner (OFS, Somerset, N.J.). Amplification of the pulses can be achieved by using a short piece of high concentration double cladding Yd-doped photonics crystal fiber 132 with large mode area (LMA) as shown in FIG. 12. The LMA of the DCYDF 132 combined with short length help reduce the SPM, (stimulated Raman scattering) SRS and balance the nonlinear effects such as SPM and XPM with the dispersion (TOD) so the pulse width will not be distorted after amplification. This DC YDF 132 can be a regular DC fiber as well in balancing the dispersion (TOD) and SPM. The chirped pulses can be further dechirped by a piece of air core photonics band gap (PBG) fiber 133 with a cross section shown in FIG. 13, which can provide large anomalous dispersion, e.g., 120 ps/nm/km, for example manufactured by Crystal Fiber, Denmark, the Part number is #HC-1060-02.

In the high power amplifier stage 130, either a PM or non-PM version of double cladding (LMA) YDF 132 can be used. In one exemplary embodiment, a LMA fiber 132 with a diameter over 40 μm core diameter is used. Spectral shaping and Pulse shaping are applied to maintain the shape of the pulse such that the pulse and spectral shape are not distorted due to the nonlinear effects. FIG. 14 shows an example for illustrating the effects of spectral shaping by comparing the normalized intensity as function of wavelength and as function of delay with and without the operations of the spectral shaping. By applying the spectral shaping on the input spectral of the signal pulse, the pulse shape of the 100 μj output pulse is significantly improved.

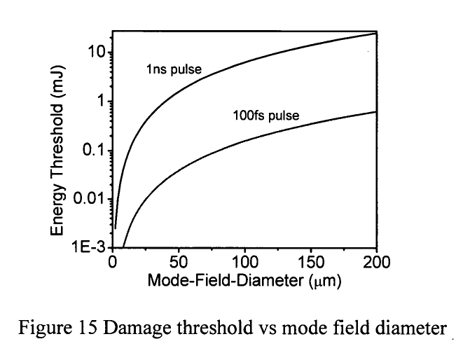

To further improve the surface damage, an end cap of a piece of coreless fiber or glass is attached to the PBG fiber 133 to increase the mode area of output beam at the end facet. As shown in FIG. 15, the damage threshold is increased thus enabling the high power ultra-short laser system of this invention to amplify the laser of 100 fs pulse to the level of mJ.

Although the present invention has been described in terms of the presently preferred embodiment, it is to be understood that such disclosure is not to be interpreted as limiting. Various alternations and modifications will no doubt become apparent to those skilled in the art after reading the above disclosure.

Accordingly, it is intended that the appended claims be interpreted as covering all alternations and modifications as fall within the true spirit and scope of the invention.

I claim:

1. A fiber laser system comprising:
a fiber mode-locking oscillator, a fiber stretcher, a multistage amplifier chain, a pulse picker, and a compressor wherein at least a device for performing a pulse shaping, a spectral shaping a polarization shaping, and/or a combination of two or three techniques thereof is implemented in said fiber mode-locking oscillator, said fiber stretcher, said multistage amplifier chain, said pulse picker, and said compressor for managing and reducing nonlinear effects in said fiber laser system.

2. The fiber laser system of claim 1 wherein:
at least one of said fiber mode-locking oscillator, said fiber stretcher, said multistage amplifier chain, said pulse picker, and said compressor are implemented with at least one of a filter, a polarization controller, a polarization splitter, an isolator, an acoustic filter, and/or a special spectral filter, to carry out said pulse shaping, spectral shaping, polarization shaping, and/or a combination of two or three techniques of said pulse shaping, polarization shaping and spectral shaping thereof.

3. The fiber laser system of claim 1 wherein:
said combinations of pulse shaping, spectral shaping and polarization shaping in different stages of said fiber laser system for generating a short pulse of 100 fs to 10 ps and a high energy laser in a range between 1 uJ to over mJ and an average power from 1 W to 100 W.

4. The fiber laser system of claim 1 wherein:
said fiber mode-locking oscillator includes a photonic crystal (PC) fiber or a PBG fiber for providing both normal and anomalous dispersions for generating predefined dispersions and dispersion slopes to match nonlinearity of said fiber mode-locking oscillator to provide optimally narrowed pulse.

5. The fiber laser system of claim 1 wherein:
said fiber mode-locking oscillator includes a fiber-based inline polarizing isolator and polarization controllers for carrying out a polarization filtering to further mange both dispersion and dispersion slopes in said fiber mode-locking oscillator.

6. The fiber laser system of claim 4 wherein:
said polarizing isolator further comprising a high extinction ratio isolator only allowing one linear polarization to pass through over a wide spectrum.

7. The fiber laser system of claim 1 wherein:
said fiber mode-locking oscillator further includes an optical coupler connected to an oscillator output fiber and a fiber Photonic crystal (PC) fiber or a Photonic band gap (PGB) fiber connected to said optical coupler.

8. The fiber laser system of claim 1 wherein:
said fiber mode-locking oscillator further includes an optical coupler connected to an oscillator output fiber and a fiber Photonic crystal (PC) fiber or a Photonic band gap (PGB) fiber connected to said optical coupler for extracting highly chirped pulse of hundreds of ps directly out from said fiber mode-locking oscillator.

9. The fiber laser system of claim 1 wherein:
said fiber stretcher further includes a fiber of flat dispersion over a range of a predefined spectral band.

10. The fiber laser system of claim 1 wherein:
said fiber stretcher further includes a fiber of flat or a negative slope dispersion over a range over a spectral band around 1020-1090 nm.

11. The fiber laser system of claim 1 wherein:
said fiber stretcher further includes a fiber for dispersively stretching a pulse over 100 ps.

12. The fiber laser system of claim 1 wherein:
said fiber stretcher further includes a fiber with a depressed cladding structure having a flat dispersion over a range over a spectral band.

13. The fiber laser system of claim 1 wherein:
said multistage amplifier chain further includes a first fiber amplifier stage included a polarization controller and a polarization beam splitter for carrying out a function of spectral and polarization shaping.

14. The fiber laser system of claim 13 wherein:
said multistage amplifier chain further includes a polarization maintenance (PM) fiber.

15. The fiber laser system of claim 13 wherein:
said multistage amplifier chain further includes a non-polarization maintenance (non-PM) fiber.

16. The fiber laser system of claim 1 wherein:
said pulse picker further includes an acousto optical modulator driven by a RF signal for down-selecting pulses for generating a predefined spectral bandwidth and shape by modifying an RF waveform and frequency of said RF signal for further enhancing an operation of spectral shaping.

17. The fiber laser system of claim 1 wherein:
said multistage amplifier chain further includes a second fiber amplifier stage implemented with a second pulse picker for preventing a performance degradation due to a noise for a sampling rate lower than 100 Khz.

18. The fiber laser system of claim 1 wherein:
said multistage amplifier chain further includes a second fiber amplifier stage implemented with a polarization maintenance (PM) fiber to maintain a spectral shape and keep a polarization unchanged from a pulse picker outputting a.

19. The fiber laser system of claim 1 wherein:
said multistage amplifier chain further includes a second fiber amplifier stage implemented with a filter to further clean up a noise band outside a signal band and modify a spectrum to compensate nonlinear effects generated in said fiber laser system.

20. The fiber laser system of claim 1 wherein:
said multistage amplifier chain further includes a second fiber amplifier stage includes a filter having various of shapes, in addition to a transform limited shapes of Gaussian or parabolic shapes, including a triangular shape and an unsymmetrical shape, for achieving a specific pulse shaping performance.

21. The fiber laser system of claim 1 wherein:
said multistage amplifier chain further includes a thin film filter, or an acousto-optic filter, or a spatial light modulator, or a polarization controller and a PBS for performing a spectral shaping.

22. The fiber laser system of claim 1 wherein:
said multistage amplifier chain further includes a polarization controller and/or a polarizer and/or a wave retarder for performing a polarization shaping.

23. The fiber laser system of claim 1 wherein:
said multistage amplifier chain further includes a high power amplifier stage implemented with a high concentration double cladding (DC) Yb-doped photonics crystal (PC) fiber as a gain medium coupling to a high power pump.

24. The fiber laser system of claim 1 wherein:
said multistage amplifier chain further includes a high power amplifier stage implemented with a high concentration double cladding (DC) Yb-doped photonics crystal (PC) fiber with a large mode area (LMA) as a gain medium coupling to a high power pump.

25. The fiber laser system of claim 1 wherein:
said compressor further comprising a piece of air core photonics band gap (PBG) fiber for providing a large anomalous dispersion.

26. The fiber laser system of claim 25 wherein:
said piece of air core photonics band gap (PBG) fiber providing a large anomalous dispersion approximately 40-200 ps/nm/km

27. The fiber laser system of claim 24 wherein:
said high concentration double cladding (DC) Yb-doped photonics crystal (PC) fiber is a PM fiber.

28. The fiber laser system of claim 24 wherein:
said high concentration double cladding (DC) Yb-doped photonics crystal (PC) fiber is a non-PM fiber.

29. The fiber laser system of claim 26 wherein:
said high concentration double cladding (DC) Yb-doped photonics crystal (PC) fiber with a LMA having a core diameter substantially about 40-200 μm.

30. The fiber laser system of claim 1 wherein:
said multistage amplifier chain further includes a high power amplifier stage that further comprising an end cap of a piece of a coreless fiber or glass attached to a PBG fiber whereby a mode area of an output beam at an end facet is increased.
